(19) United States
(12) Patent Application Publication
(10) Pub. No.: US 2004/0039100 A1
(43) Pub. Date: Feb. 26, 2004

(54) Radiation curable compositions

(76) Inventors: Norazmi Alias, Senawang (MY); Kris Verschueren, Groot-Bijgaarden (BE)

Correspondence Address: WENDEROTH, LIND & PONACK, L.L.P., 2033 K STREET N. W., SUITE 800, WASHINGTON, DC, 20006-1021, US

(21) Appl. No.: 10/432,027

(22) PCT Filed: Nov. 16, 2001
(86) PCT No.: PCT/EP01/13250

(30) Foreign Application Priority Data
Nov. 17, 2000 (MY) PI20005414

(51) Int. Cl. B05D 3/00; B05D 5/00; C08K 3/00

(52) U.S. Cl. 524/502; 427/551; 427/271

(57) ABSTRACT

A photo-resist composition is disclosed that is a partial esterification product of a styrene maleic anhydride copolymer with (meth)acrylate and hydroxyl containing side chains. An amide containing (meth)acrylate is optionally present. These compositions exhibit a good balance between UV cure rate, tack free properties, and dissolution of uncured composition by dilute alkaline solution.

### FIELD OF THE INVENTION

This invention relates to radiation curable compositions and in particular to their use as liquid photo-resist compositions for the fabrication of articles such as printed circuit boards. The radiation curable compositions are removable when they are not cured by an aqueous alkaline water. In a printed circuit board the circuitry images are defined by the cured composition area that remains after the alkaline removal of the uncured areas.

### BACKGROUND TO THE INVENTION

Typically printed circuit boards are fabricated by applying a radiation curable coating to the copper surface of the board. A negative film of the desired circuit image is then applied to the curable coating and the film is exposed to a UV light source. After the coating is cured the printed circuit board is washed in an aqueous alkaline solution to remove the coating areas that were not exposed to the UV light source. The board is then etched to remove the uncoated copper regions. Other imagining techniques may be used. In addition to this use for forming printed circuit boards, these techniques can be used to form other surfaces such as printing plate surfaces. In this field radiation curable compositions are termed photo-resist compositions.

Photo-imageable compositions useful as photo-resists in forming printed circuit boards are taught in U.S. Pat. No. 3,953,309. The photo-imageable composition contains photo-polymerisable material to render it curable by irradiation, a photo-initiator system, and acid functional binder to allow for developing in alkaline solution. The presence of acid groups such as carboxylic acid in the photo-polymerisable material is necessary to make the photo-resist compositions developable in alkaline solution. The presence of the acid groups also allows the removal of the photo cured composition, if required, by immersion in a second bath that is more alkaline than the developing bath solution. However, this requirement is a disadvantage if it is desired that the cured coating remain and the subsequent processing solutions are alkaline. In this case the photo-polymerised portions would be subjected to degradation in the highly alkaline solution like the ammoniacal etchants or metal plating solutions. Under these conditions, such photo-resist would be subjected to delamination and stripping.

U.S. Pat. No. 4,943,516 teaches a photosensitive thermosetting composition containing a photosensitive polymer based on acid functional epoxy (meth)acrylates and a finely powdered epoxy compound useful in liquid photo-imageable solder mask. The composition described in this patent is excellent in chemical and thermal resistance but lacks fast drying. Typically a long drying time is required to produce a tack-free surface prior to contact copying to image the circuit pattern onto the photo-resist coating. Attempts to speed the tack-free time by using ovens is usually unsatisfactory. Long residence times in an oven make the photo-resist susceptible to picking up dust particles and this can produce micro-defects during the subsequent photo-imaging step.

FR 2,253,772 teaches a photo-polymerisable composition for lithographic plates or a photo-resist and it comprises an addition copolymer of maleic anhydride with vinyl or styrene monomers. This copolymer is then esterified with an ethylenically unsaturated alcohol or a polyol which itself is partially esterified with an unsaturated aliphatic acid. The unsaturated alcohol or polyol may contain alkoxy groups. The presence of water or alkaline sensitive groups such as alkoxy (ethoxy or methoxy) groups may improve the alkaline developability of the unpolymerised region of the photo-resist but also degrades the acid and alkaline resistance of the cured photo-resist in the subsequent acidic or alkaline etching solution. In addition, the incomplete opening of the anhydride (60-80% reacted) will subsequently reduce the alkaline developability of the photo-resist.

U.S. Pat. No. 5,296,334 teaches a polymerisable composition for use as a solder mask. This composition contains a binder polymer made from the esterification product of a styrene maleic anhydride copolymer with less than 15% free anhydride, with at least 50% of the available anhydride groups esterified with a hydroxy alkyl (meth)acrylate, and at least 0.1% of available anhydride groups being esterified with monohydric alcohols. It also contains a multifunctional (meth)acrylate monomer and a multifunctional epoxide. The use of high concentrations of (meth)acrylate monomers such as TMPTA, TPGDA or DPHA, increases the UV reactivity of the photo-resist. However, this generally adds to the tackiness of the photo-resist composition.

U.S. Pat. No. 4,370,403 teaches a polymerisable composition based on (a) reaction product of styrene maleic anhydride copolymer and 2-hydroxyethyl acrylate, (b) other ethylenically unsaturated compounds and (c) photo-initiator.

U.S. Pat. No. 4,722,947 describes a radiation curable polymer based on reaction of styrene/maleic anhydride copolymer with hydroxy alkyl acrylate and another alcohol, such as an arylalkyl monohydric alcohol. The presence of an alcohol with no acrylate unsaturation decreases the UV reactivity and the resultant UV cross-linking of the coating. This leads also to a reduction in the chemical resistance of the photo-resist in subsequent alkaline or acidic processing.

U.S. Pat. No. 4,723,857 describes the photo-imageable compositions containing styrene/maleic anhydride copolymer partially esterified with methanol and isopropanol. The resultant polymer is acidic in nature but contains no acrylate unsaturation to render it photo-polymerisable under ultraviolet irradiation.

WO 98/457755 (Advanced Coatings International) describes certain waterborne dispersions of aliphatic urethane acrylate oligomers for use in making photo-resists.

It is desirable that photo-resist compositions have short tack-free times and relatively short times for dissolution in alkaline solution.

### SUMMARY OF THE INVENTION

The present invention provides in one form a radiation curable composition that is developable in aqueous alkaline solution and which comprises:

(a) a copolymer which is a partial esterification product of a styrene maleic anhydride copolymer with at least two hydroxy containing compounds of Formula I,

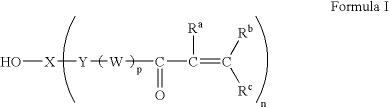

where

p is 0 or 1 (i.e. when p is 0 then Y is directly attached to the carbonyl group);

n is an integer from 1 to 7;

R^{a}, R^{b} and R^{c} are independently H or methyl, preferably R^{a} is methyl or H and R^{b} and R^{c} are both H (i.e. Formula I denotes a (meth)acrylate);

X and W independently represent a divalent optionally substituted organo linking moiety preferably selected from a group consisting of one or more optionally substituted hydrocarbo, hydrocarbo ether; poly(hydrocarbo ether); hydrocarbo ester, poly(hydrocarbo ester) and poly(hydrocarbo ether hydrocarbo ester); more preferably selected from the group consisting of: alkylene, alkylene ether, polyether, polyester, alkylene ester and polyether polyester;

Y is oxo (—O—), imino (—NH—) or hydrocarbo substituted imino (—NR₁—, where R₁ is hydrocarbo, preferably alkyl);

(b) optionally a partial esterification product of a styrene maleic anhydride copolymer with one or more hydroxyl containing compounds of the following formulae:

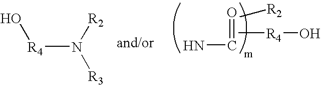

(i.e. either substituent may be attached to either the N or C atoms of the N-substituted carbamoyl moiety); such that

R₂ and R₃ independently represent H or optionally substituted hydrocarbo, preferably optionally substituted alkyl, aryl, cycloalkyl, or arylalkyl

R₄ independently in each case represents a direct bond (i.e. where the OH is attached to the nitrogen or carbonyl) or a divalent optionally substituted organo linking moiety, preferably optionally substituted hydrocarbo; more preferably optionally substituted alkylene, arylene, cycloalkylene, or arylalkylene; and

m is 1 or greater; and

(c) optionally an amide comprising one or more (meth)acrylate group(s).

In an alternative form the invention provides a radiation curable composition which comprises:

(a) a blend of copolymers which are a partial esterification product of a styrene maleic anhydride copolymer with compounds of Formula II;

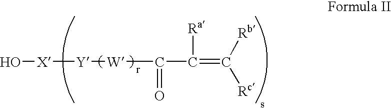

where

r is 0 or 1 (i.e. when r is 0 then Y′ is directly attached to the carbonyl group);

s is an integer from 1 to 7;

R^{a′}, R^{b′} and R^{c′} are independently H or methyl, preferably R^{a′} is methyl or H and R^{b′} and R^{c′} are H (i.e. Formula II denotes a (meth)acrylate);

X′ and W′ independently represent a divalent optionally substituted organo linking moiety preferably selected from a group consisting of one or more optionally substituted hydrocarbo, hydrocarbo ether; poly(hydrocarbo ether); hydrocarbo ester, poly(hydrocarbo ester) and poly(hydrocarbo ether hydrocarbo ester); more preferably selected from the group consisting of: alkylene, alkylene ether, polyether, polyester, alkylene ester and polyether polyester;

Y′ is oxo (—O—), imino (—NH—) or hydrocarbo substituted imino (—NR′₁—, where R′₁ is hydrocarbo, preferably alkyl);

(b) optionally a partial esterification product of a styrene maleic anhydride copolymer with one or more hydroxyl containing compounds of the following formulae:

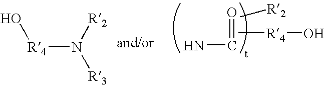

and/or (i.e. either substituent may be attached to either the N or C atoms of the N-substituted carbamoyl moiety); such that

R′₂ and R′₃ independently represent H or optionally substituted hydrocarbo, preferably optionally substituted alkyl, aryl, cycloalkyl, or arylalkyl

R′₄ independently in each case represents a direct bond (i.e. where the OH is attached to the nitrogen or carbonyl) or a divalent optionally substituted organo linking moiety, preferably optionally substituted hydrocarbo; more preferably optionally substituted alkylene, arylene, cycloalkylene, or arylalkylene; and

t is 1 or greater; and

(c) an amide comprising one or more (meth)acrylate group(s).

### DETAILED DESCRIPTION OF THE INVENTION

The copolymer of the present invention is preferably prepared by esterification of at least 50 mole % of the free anhydride groups in the styrene maleic anhydride copolymer with hydroxy alkyl (meth)acrylates, and less than 50 mole % of the free anhydride groups with caprolactone—or alkoxy—containing hydroxy (meth)acrylates. In order to assure nearly all of anhydride is opened, the reaction is preferably carried out with an excess of hydroxyl groups.

The reaction of the anhydride and hydroxyl monomers is usually carried out in the presence of organic solvents. Typical solvents used for liquid photo-resist systems are propylene glycol mono methyl ether, propylene glycol mono methyl ether acetate, butyl ether glycol acetate, and butyl carbitol acetate. The solvent is typically first charged into a glass vessel and heated slowly to 60° C. At this temperature a styrene maleic anhydride copolymer may be added along with polymerisation inhibitors to prevent thermal polymerisation of the (meth)acrylate unsaturation. Typical inhibitors used are hydroquinone and its derivatives triphenyl antimony, and trionyl phenyl phosphine. The hydroxyl (meth)acrylate monomer may then be added into the copolymer solution in the vessel. The temperature can then be increased to 90° C. to 100° C., and held until nearly all the anhydride groups are opened. Complete reaction can be established when the acid value of the reaction product nearly equals the acid value of the semi-ester.

Two different methods may be used to prepare the copolymer. The first is by reacting the styrene maleic anhydride copolymer separately with two different types of hydroxyl (meth)acrylates, and then blending these two different copolymers such that the mixture contains partial esterification products of the styrene maleic anhydride with two different hydroxyl (meth)acrylates. The second method is to react the styrene maleic anhydride copolymer simultaneously with two different hydroxyl (meth)acrylates. A typical structure of a copolymer of the invention is:

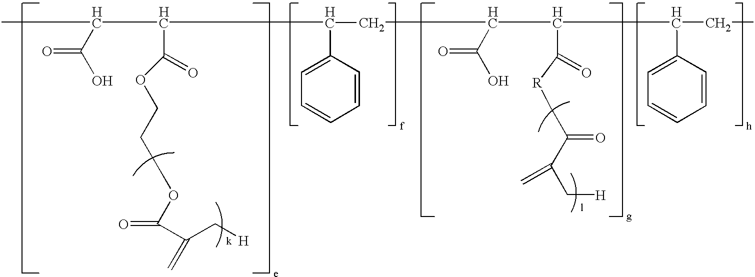

such that R is a divalent alkyl ester, divalent alkyl ether moiety,

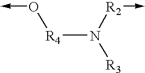

and/or

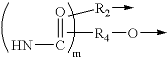

(i.e. either divalent substituent may be attached to either the N or C atoms of the N-substituted carbamoyl moiety) where m, R₂, R₃ and R₄ are as given herein (except R₂ is divalent) and preferably m is 1;

e, f, g and/or h preferably independently represent 1 or greater, more preferably an integer from 1 to 7 (inclusive); and

k and l independently represent 0 or an integer from 1 to 7 (inclusive).

More preferably when l is 0 then R is

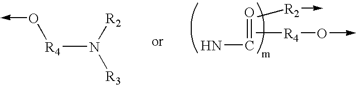

More preferably when l is from 1 to 7 then R is a divalent alkyl ester or divalent alkyl ether moiety.

Styrene maleic anhydride copolymers are commercially available resins such as SMA resins from Elf Atochem, and Leumal resins from Leuna Harze GmbH. The preferred styrene maleic anhydride copolymer resins has molecular weight between 1000 and 30,000 and a mole ratio of styrene to maleic anhydride in the respective range of about (1 to 1) to about (3 to 1).

Examples of suitable hydroxyl alkyl (meth)acrylates for partial esterification with the styrene maleic anhydride copolymer are 2-hydroxyethyl acrylate, 2-hydroxyethyl methacrylate, 2-hydroxypropyl acrylate, hydroxylpropyl methacrylate, n-methylol methacrylamide and n-methylol acrylamide. Examples of hydroxyl monomers with more than one (meth)acrylate groups are ditrimethylopropane triacrylate, pentaerythritol triacrylate, and dipentaerythritol pentaacrylate. (Meth)acrylate monomers with functionality greater than one are preferred when very high photosensitivity of the photo-resist composition is desired.

Examples of caproloactone containing hydroxyl (meth)acrylate are commercially available from Union Carbide Corporation under the trade names Tone M-100 and M-200.

Examples of alkoxy-containing hydroxyl (meth)acrylate are polyethyleneglycol monoacrylate, polyethyleneglycol monomethacrylate, polypropyleneglycol monoacrylate, polypropyleneglycol monomethacrylate, and mixtures of ethylene and propylene glycol such as polyalkyleneglycol monomethacrylate. Examples of these are available from Inspec under the trade names Bisomer PEM63P and PPM63E.

Examples of monofunctional amide-containing (meth)acrylates are those containing at least one amide linkage and at least one (meth)acrylate functional group. The amido (meth) acrylate may be nonfunctional or polyfunctional especially difunctional. Preferred amido (meth)acrylates are those prepared from reaction of gamma-butyrolactone and alkylamine, alkanolamine or alkyl diamine to produce amido alcohols, and the amido alcohols are further reacted with methyl (meth)acrylate by transesteritication to produce amido (meth)acrylates with the byproduct of mono alcohol which is distilled under vacuum. Preferred amido (meth)acrylates in this invention are set out below.

Monofunctional amido (meth)acrylate:

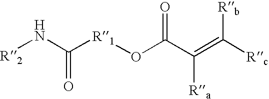

where:

R″₂ is alkyl, aryl, arylalkyl or cycloalkyl;

R″₁ is divalent alkylene, arylene, arylalkylene or cycloalkylene; and

R″ₐ, R″_{b} and R″_{c} are independently H or methyl; preferably R″ₐ is H or methyl and R″_{b} and R″_{c} are both H.

Difunctional amido (meth)acrylate:

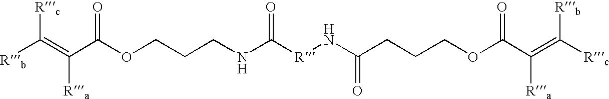

where R′″ₐ, R′″_{b} and R′″_{c} are independently H or methyl; preferably R′″ₐ is H or methyl and R′″_{b} and R′″_{c} are both H; and

R′″ is divalent alkylene, or

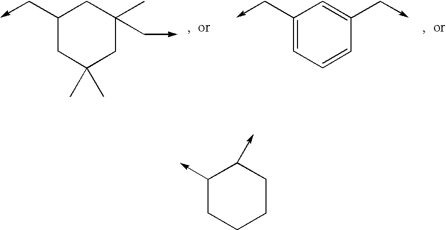

Another example of difunctional amido (meth)acrylate is:

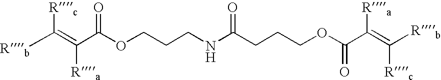

where R″″ₐ, R″″_{b} and R″″_{c} are independently H or methyl; preferably R″″ₐ is H or methyl and R″″_{b} and R″″_{c} are both H.

Preferred respective weight ratios of amide-containing (meth)acrylates to SMA copolymer adducts are from about (1 to 2) to about (1 to 10) and more preferably from about (1 to 3) to about (1 to 6).

It is not essential that all the maleic anhydride rings of the copolymer are reacted with (meth)acrylate monomers. For example, minor amounts of amine or hydroxyl containing moieties may be used to form non (meth)acrylate amide or ester side chains respectively.

These side chains may influence the overall solubility of the copolymer composition, especially in dilute alkaline solutions. An example of a possible non (meth)acrylate side chain is methoxy polyethyleneglycol. Another example is an alkanolamine of formula HONR²R³ as well as an amido alcohol of formula HO(NHCO)_{m′}R²; where R² and/or R³ may be independently alkyl, aryl, cycloalkyl, arylalkyl and m′ is 1 or greater.

The radiation curable composition in this invention are useful in liquid photo-resist compositions in the fabrication of printed circuit boards. In order to be used as liquid photo-resist, the radiation curable composition needs to be formulated into a photo-resist ink. This formulation is well known to one skilled in the art. A typical liquid photo-resist ink for etching resist may comprise (by % weight of the total composition) from about 60% to about 80% of acid functional oligomer, up to about 10% of optional filler(s), from about 5% to about 10% of multifunctional (meth)acrylate monomer(s), from about 1% to about 2% of pigment(s) (such as a phthalocyanine blue pigment), from about 1% to about 2% of PE or PTFE wax, from about 1% to about 2% of flow (rheology) additives, and from about 5% to about 7% of a photo-initiator system.

Suitable fillers for the preparation of liquid photo-resist are typically inert inorganic type of fillers based on silica, aluminia, calcium carbonate, clay aerosol and any mixture. Multifunctional (meth)acrylate monomers or meth(acrylate) diluents that are useful for adjusting the ink viscosity and increasing the photo-resist compositions. Typical multifunctional (meth)acrylates or meth(acrylate) diluents are hydroxyethyl methacrylate, hydroxypropyl acrylate and methacrylate, trimethylolpropane triacrylate and trimethacrylate, pentaerythritol triacrylate and tetraacrylate, dipentaerythritol hexaacrylate, and any mixtures of these.

Suitable photo-initiators for photo-resist application include 2-benzyl-2-N,N-dimethylamino-1-(4-morpholinophenyl)-1-butanone commercially available as Irgacure 369 and 2-methyl-1-(4-methylthiophenyl)-2-morpholino propan-1-one commercially available as Irgacure 907. These photo-initiators are typically used in combination with thioxanthone sensitisers such as 2,4-diethylthioxanthone, 2- and 4-isopropylthioxanthone, and 2- and 4-chlorothioxanthone.

Additionally organic solvents can be required to adjust the viscosity of the photo-resist ink for different applications. These solvents can be used alone or in any combination. Suitable organic solvents include butyl cellosolve, butyl cellosolve acetate, propylene glycol methyl ether, propylene glycol methyl ether acetate, dipropylene glycol and diethyl ether.

The terms ‘optional substituent’ and/or ‘optionally substituted’ as used herein (unless followed by a list of other substituents) signifies the one or more of following groups (or substitution by these groups): carboxy, sulphol formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen and/or sulphur, more preferably from hydrogen, nitrogen, oxygen and/or sulphur.

The term ‘hydrocarbo group’ as used herein is a sub-set of a organic group and denotes any univalent or multivalent moiety (optionally attached to one or more other moieties) which consists of one or more hydrogen atoms and one or more carbon atoms. Hydrocarbo groups may comprise one or more of the following groups. Hydrocarbyl groups comprise univalent groups formed by removing a hydrogen atom from a hydrocarbon. Hydrocarbylene groups comprise divalent groups formed by removing two hydrogen atoms from a hydrocarbon the free valencies of which are not engaged in a double bond. Hydrocarbylidene groups comprise divalent groups (represented by “R₂C═”) formed by removing two hydrogen atoms from the same carbon atom of a hydrocarbon, the free valencies of which are engaged in a double bond; Hydrocarbylidyne groups comprise trivalent groups (represented by “RC═”), formed by removing three hydrogen atoms from the same carbon atom of a hydrocarbon the free valencies of which are engaged in a triple bond. Hydrocarbo groups may also comprise any saturated, unsaturated double and/or triple bonds (e.g. alkenyl, and/or alkynyl respectively) and/or aromatic groups (e.g. aryl) and where indicated may be substituted with other functional groups.

Most preferably organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group):

The term ‘alkyl’ or its equivalent (e.g. ‘alk’) as used herein may be readily replaced, where appropriate and unless the context clearly indicates otherwise, by terms encompassing any other hydrocarbo group such as those described herein.

Any substituent, group or moiety mentioned herein refers to a monovalent species unless otherwise stated or the context clearly indicates otherwise (e.g. an alkylene moiety may comprise a bivalent group linked two other moieties). A group which comprises a chain of three or more atoms signifies a group in which the chain wholly or in part may be linear, branched and/or form a ring (including Spiro and/or fused rings). The total number of certain atoms may be specified for certain substituents for example C₁₋ₓorgano, signifies an organic group having from 1 to x carbon atoms. In any of the formulae herein if one or more substituents are not indicated as attached to any particular atom on the moiety, the substituent may replace any hydrogen atom attached to another atom and/or may be located at any available position on the moiety which is chemically suitable and/or where there is a free valence (which may be indicated in the formulae herein by an arrow).

Parts of some chemical terms used herein are given in parentheses and unless the context dictates otherwise (e.g. parentheses in an IUAPC name), these denote that the parenthetic moiety is optional. For example as used herein the term “(meth)acrylate” denotes both methacrylate and acrylate.

Some of the organic groups such as hydrocarbo, alkyl etc listed herein do not have the number of carbon atoms specified in which case preferably such groups comprise from 1 to 36 carbon atoms, more preferably from 1 to 18 carbon atoms. It is particularly preferred that the number of carbon atoms in such groups is from 1 to 10 inclusive.

Unless the context clearly indicates otherwise, as used herein plural forms of the terms herein are to be construed as including the singular form and vice versa.

The term ‘effective’ (for example with reference to the process, uses, products, materials, compounds, monomers, oligomers, polymer precursors and/or polymers of the present invention) will be understood to refer to those ingredients which if used in the correct manner provide the required properties to the material, compound, composition, monomer, oligomer, polymer precursor and/or polymer to which they are added and/or incorporated in any one or more of the uses and/or applications described herein. As used herein the term “suitable” denotes that a functional group is compatible with producing an effective product.

The substituents on the repeating unit may be selected to improve the compatibility of the materials with the polymers and/or resins in which they may be formulated and/or incorporated to form an effective material. Thus, the size and length of the substituents may be selected to optimise the physical entanglement or interlocation with the resin or they may or may not comprise other reactive entities capable of chemically reacting and/or cross-linking with such other resins.

Certain moieties, species, groups, repeat units, compounds, oligomers, polymers, materials, mixtures, compositions and/or formulations which comprise some or all of the invention as described herein may exist as one or more stereoisomers (such as enantiomers, diastereoisomers, geometric isomers, tautomers and/or conformers), salts, zwitterions, complexes (such as chelates, clathrates, crown compounds, cyptands/cryptades, inclusion compounds, intercalation compounds, interstitial compounds, ligand complexes, non-stoichiometric complexes, organometallic complexes, π-adducts, solvates and/or hydrates); isotopically substituted forms, polymeric configurations [such as homo or copolymers, random, graft or block polymers, linear or branched polymers (e.g. star and/or side branched polymers), hyperbranched polymers and/or dendritic macromolecules (such as those of the type described in WO 93/17060), cross-linked and/or networked polymers, polymers obtainable from di and/or tri-valent repeat units, dendrimers, polymers of different tacticity (e.g. isotactic, syndiotactic or atactic polymers)]; polymorphs [such as interstitial forms, crystalline forms, amorphous forms, phases and/or solid solutions] combinations thereof where possible and/or mixtures thereof. The present invention comprises all such forms which are effective.

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination.

The term “comprising” as used herein will be understood to mean that the list following is non-exhaustive and may or may not include any other additional suitable items, for example one or more further feature(s), component(s), ingredient(s) and/or substituent(s) as appropriate.

Further aspects of the present invention are described in the claims herein.

### DESCRIPTIONS OF PREFERRED EMBODIMENT

The invention will be described by reference to the following examples of preferred embodiments which are non-limiting.

### EXAMPLE 1

This Example illustrates the preparation of copolymer used in compositions according to the present invention.

The amount of 195.4 grams of the styrene maleic anhydride copolymer, SMA 3000 (having a molecular weight of 10,000 and styrene to maleic anhydride mole ratio of 3 to 1 and available commercially from Elf Atochem under the SMA 3000 trade designation) and 180 grams of propylene glycol methyl ether acetate were charged to a stirred one litre three-neck glass vessel and heated to 85-90° C. to dissolve the copolymer. To this solution 0.27 grams of hydroquinone and 0.27 grams of triphenyl stibene inhibitors were added. A mixture of 75.9 grams of hydroxyethyl methacrylate and 0.54 grams of 4-ethyl morpholine was slowly added into the reaction vessel over a period of one hour. The reaction mixture was held at 90° C. for eight to twenty four hours until the total acid value equaled the theoretical partial acid value, or until the total acid value stopped reducing. The reaction mixture was post-stabilised with 0.22 grams of trinonylphenyl phosphine inhibitor. The final acid value of the copolymer ester was 117 mg KOH/gm and its non-volatile content was 60%. This copolymer semi-ester was designated A.

The amount of 335 grams styrene maleic anhydride copolymer, SMA3000, and 245 grams of propylene glycol ether acetate were charged into a stirred one-litre three-neck glass vessel and heated to 90° C. to dissolve the copolymer. To this solution 0.68 grams hydroquinone and 0.68 grams of triphenyl stibene inhibitors were added. A mixture of 344 grams of Tone M-100 (a caprolactone-based hydroxyl monomer from Union Carbide) and 1.36 grams of 4-ethyl morpholine inhibitor was slowly added to the reaction vessel over a period of one hour. The reaction mixture was held at 90° C. for eight to sixteen hours until the total acid value equaled the theoretical partial acid value. The mixture was post-stabilised with 0.54 grams of trionylphenyl phosphine. The final acid value of the copolymer ester was 89 mg KOH/mg and the total non-volatile content was 74%. This copolymer semi-ester was designated B.

The amount of 335 grams of styrene maleic anhydride copolymer, Leumal 501L/100 (from Leuna Harze GmbH), with molecular weight of 30,000 and styrene to maleic anhydride mole ratio of 3:1 and 474 grams of propylene glycol methyl ether acetate were charged into a stirred two-litre three-neck glass vessel and heated to 85° C. to 90° C. to dissolve the copolymer. 0.71 grams of hydroquinone and 0.71 grams of triphenyl stibene inhibitor were added. A mixture of 376 grams of Bisomer PPM5S (propylene glycol methacrylate with 5 propylene oxide linkages from Inspec) and 1.42 grams of 4-ethyl morpholine was added into the reaction vessel over a period of one hour. The mixture in the vessel was held at 90° C. for eight to twenty four hours until the total acid value equaled the theoretical partial acid value. The mixture was then post-stabilised with 0.57 grams of trinonylphenyl phosphine.

The final acid value of the copolymer ester was 124 mg KOH/gm and the non-volatile content was 60%. This copolymer semi-ester was designated C.

### EXAMPLE 2

This Example illustrates the preparation of copolymer compositions according to the present invention.

The amount of 133.4 grams of copolymer semi-ester A and 118.3 grams of copolymer semi-ester B were charged to a one litre stirred vessel and heated to 60° C. The acid value of the homogenous mixture was 174 mg KOH/mg, and the non-volatile content was 67%. This copolymer mixture was designated D.

### EXAMPLE 3

This example evaluates the tack-free and alkaline developability of copolymers A, B and C.

Each of the copolymers was evaluated for tack-free and alkaline solubility in 1% Na₂CO₃ solution by the following methods.

(1) Time to Tack-Free.

A copolymer was coated onto a cleaned copper board using a #16 wire drawdown bar to give an approximately 20-30 μm thick wet film. The coated board was then placed in an 80° C. oven. The tackiness was checked at 5 minute intervals commencing immediately after the board was removed from the oven. The copolymer film was rated as tack-free if no finger marks were left on the film surface.

(2) Alkaline Solubility.

The solubility of the copolymer in 1% Na₂CO₃ solution at 30° C. was determined using a spraying unit containing the alkaline solution. The amount of copolymer left on the board was checked after periodic spraying with the alkaline solution at intervals of 30 seconds.

Results of the tack-free and alkaline solubility are in given the following table:

| | Time to tack-free | Time for complete solubility |
|---|---|---|
| Copolymers | (hot-tack) | in 1% Na₂CO₃ |
| A | 5 mins | >1 minute (with residue) |
| B | >20 mins., tack-free @ RT | 30 secs. |
| C | >20 mins., tack-free @ RT | 30 secs. |

### EXAMPLE 4

This Example illustrates the improvement in tack-free and alkaline developability by using mixtures of copolymers A, B and C.

Various mixtures of copolymers A, B and C were evaluated in a photo-resist formulation for tack-free and alkaline solubility. Firstly a photo-resist ink based on copolymer A was prepared as follows:

Photo-resist Formulation A

| | |
|---|---|
| Copolymer A | 40 grams |
| HEMA | 21 grams |
| DPHA | 5 grams |
| Micronised talc | 30 grams |
| Phthalocyanin green | 2 grams |

This photo-resist formulation was in turn further mixed with copolymers B and C for comparison as follows, where the proportions are by weight:

| Formulation | I | II | III |
|---|---|---|---|
| Photo-resist A | 70 | 65 | 65 |
| Copolymer B | 25 | 0 | 0 |
| Copolymer C | 0 | 25 | 30 |
| TMP(EO)TA | 0 | 5 | 0 |
| Irgacure 907 | 3 | 3 | 3 |
| ITX | 1 | 1 | 1 |
| Ebecryl 375 | 1 | 1 | 1 |
| Flash off time | 5 minutes | 15 minutes | 10 minutes |
| Tack-free | Yes | No | Yes |
| Time for complete | 30-45 | 45 seconds | 90 seconds |
| solubility in 1% Na₂CO₃ | seconds | | |

### EXAMPLE 5

This Example illustrates the tack-free and alkaline developability of mixtures of copolymer A and amido (meth)acrylates.

Various mixtures of copolymer A and amido (meth)acrylates were evaluated in photo-resist formulation for tack-free and alkaline solubility. The amido (meth)acrylates were mixed in photo-resist Formulation A as follows, where the examples are by weight. Amido acrylate I is a mono functional amido acrylate as described earlier, where R₁ and R₂ are butyl groups.

Amido Acrylate II is a difunctional amido acrylate as described earlier where R is a butyl group. Amido Acrylate III is a difunctional amido acrylate as described where R is an isophorone group.

| Formulation | IV | V | VI | VII | VIII | IX |
|---|---|---|---|---|---|---|
| Photo-resist A | 100 | 70 | 90 | 90 | 90 | 90 |
| TMP(EO)TA | 0 | 30 | 10 | 0 | 0 | 0 |
| Amido acrylate I | 0 | 0 | 0 | 10 | 0 | 0 |
| Amido acrylate II | 0 | 0 | 0 | 0 | 10 | 0 |
| Amido Acrylate III | 0 | 0 | 0 | 0 | 0 | 10 |
| Flash off time | 5 | 30 | 30 | 8 | 8 | 8 |
| | mins | mins | mins | mins | mins | mins |
| Tack-free while hot | Yes | No | No | Yes | Yes | Yes |
| Time to complete | 120 | 30-45 | 45 | 30-40 | 45-60 | 45-60 |
| solubility in 1% | secs | secs | secs | secs | secs | secs |
| Na₂CO₃ | | | | | | |

Formulations VII, VIII and IX demonstrated both excellent tack-free and rapid times for complete alkaline solubility.

### EXAMPLE 6

This example compares copolymers of the present invention typically used in liquid photo-imageable etch resist formulations.

Comparative Resin I

A resin solution was prepared by compounding 30% by weight in propylene glycol mono methyl ether solvent, a equal weight mixture of acid functional high MW acrylic copolymer (Joncryl 690 of Johnson Polymer; and Scripset 540 from Hercules) and (meth)acrylate monomers TMP(EO)TA, TMPTA and hydroxyethyl methacrylate. The final acid value of Comparative Resin I was 120 mg KOH/gm.

Comparative Resin II

A resin solution was prepared by ring opening epoxy novolak resin with (meth)acrylic acid. This resin was then acidified with tetrahydrophthalic anhydride. The reaction was carried out in propylene glycol methyl ether acetate. The final acid value of Comparative Resin II was 85 mg .KOH/gm and its total non-volatile content was 70%.

| | Parameters/Formulation | | | | |
|---|---|---|---|---|---|
| | X | XI | XII | XIII | XIV |
| Comparative Resin I | 49 | 0 | 0 | 0 | 0 |
| Comparative Resin II | 0 | 53.2 | 0 | 0 | 0 |
| Oligomer Mixture I | 0 | 0 | 0 | 31.23 | 34.60 |
| Oligomer Mixture II | 0 | 0 | 0 | 15.00 | 4.90 |
| Oligomer Mixture IV | 0 | 0 | 48.9 | 0 | 0 |
| Amido (Meth)acrylate II | 0 | 0 | 0 | 0 | 4.45 |
| Micronised talc | 28.6 | 28.5 | 28.5 | 23.42 | 25.95 |
| Irgalite Blue LGK | 1.4 | 0 | 1.4 | 0 | 0 |
| Irgalite Green GLPO | 0 | 1.9 | 0 | 1.56 | 1.73 |
| Aerosil R972 | 1.9 | 0 | 1.9 | 0 | 0 |
| Tergodisperse 710 | 0 | 0 | 0 | 0.85 | 0.98 |
| HEMA | 4.8 | 4.75 | 5.1 | 16.39 | 18.16 |
| DPHA | 4.8 | 4.75 | 4.7 | 3.90 | 4.32 |
| Ebecryl 375 | 0 | 1 | 0 | 0 | 0 |
| Photo-initiator Mixture: | | | | | |
| Irgacure 907 | 4.3 | 3 | 4.3 | 3.83 | 4.41 |
| ITX | 0.5 | 1 | 0.5 | 0.43 | 0.49 |
| HEMA | 0 | 0 | 4.7 | 0 | 0 |
| Propylene glycol methyl | 4.8 | 0 | 0 | 4.25 | 0 |
| ether | | | | | |

| | Formulation/Properties | | | | |
|---|---|---|---|---|---|
| | X | XI | XII | XIII | XIV |
| Flash off time | 6-7 | 20 | 8-9 | 5 | 10 |
| (minutes at 80° C.) | | | | | |
| Tack-Free while hot | Yes | No, but | Yes | Yes | Yes |
| | | tack- | | | |
| | | free at | | | |
| | | room | | | |
| | | temp. | | | |
| Dried film thickness | ˜10 | ˜10 | ˜10 | ˜10 | ˜10 |
| | μm | μm | μm | μm | μm |
| Pencil hardness after UV | >3 | >3 | >3 | n.a.* | n.a. 8 |
| exposure | H | H | H | | |
| Stouffer 21- | | | | | |
| steps sensitivity | | | | | |
| @ 60 mJ/cm² | 2-3 | n.a* | 2-3 | 1-2 | 2-3 |
| @ 120 mJ/cm² | 4-5 | n.a* | 3-4 | 2-3 | 4-5 |
| @ 240 mJ/cm² | 6-7 | 5-6 | 7-8 | 5-6 | 6-7 |
| @ 360 mJ/cm² | n.a.* | 8-9 | 9-10 | n.a.* | 7-8 |
| @ 480 mJ/cm² | 7-8 | 10-11 | 9-10 | n.a.* | n.a* |
| Development in 1% | 30 | 30 | 30 | 30 | 35 |
| Na₂CO₃ @ 30° C. | sec. | sec. | seconds | sec. | sec. |
| Etching Resistance (35% | OK, but | n.a.* | OK, but | n.a* | n.a.* |
| FeCl₃ 30° C., 3 minutes) | attack | | attack | | |
| | of 50 μm | | of 50 μm | | |
| | lines | | lines | | |
| Stripping | 30 | n.a.* | 45 | n.a* | n.a.* |
| (5% NaOH, 30° C.) | secs | | secs | | |
| Lines and spaces | 75/75 | 50/50 | 75/75 | 50/50 | 50/50 |
| (μm/μm) | | | | | |

n.a.* = not tested at these conditions.

### EXAMPLE 7

Synthesis of SMA with Hydroxyethyl Methacrylate and Dimethylaminoethanol

The following ingredients were charged into a 2-liter glass reactor vessel: 88 grams hydroxyethyl methacrylate, 241 grams dimethylaminoethanol, 2.0 grams 4-ethyl morpholine, 0.5 grams hydroquinone and 0.5 grams triphenylstibene. The mass was heated in the reactor to 50° C. Then 671 grams of SMA 3000P (as described in Example 1, herein) and 300 grams of methoxy propanol were added in three different portions over 1 hour. Then, 178 grams of hydroxyethyl methacrylate was added in two portions over 2 hours. The mass temperature was allowed to exotherm to 90° C., and the temperature was held there for 5 to 10 hours until the acid value of the mass reached 100-105 mg KOH/gm. The resultant polymer was designated Copolymer E.

### EXAMPLE 8

Synthesis of SMA with Hydroxyethyl Methacrylate and Dimethylaminoethanol

The following ingredients were charged into a 2-liter glass reactor vessel: 328 grams hydroxyethyl methacrylate, 2.0 grams 4-ethylmorpholine, 0.5 grams hydroquinone and 0.5 grams triphenyl stibine. The mass was heated in the reactor to 50° C. Then 617 grams of SMA 3000P (as described in Example 1, herein) and 100 grams of methoxypropanol were charged into the vessel over 30 minutes. The mass temperature was allowed to exotherm to 90° C., and held at this temperature for 1 hour. Then 55 grams of dimethylaminoethanol and 200 grams of methoxypropanol were added and the mixture was held at 90° C. to 100 C. for 5 to 10 hours until the acid value-of the mass was 110-115 mg KOH/gm. The resultant polymer was designated Copolymer F.

Application Tests

A mixture of 75 wt % of Copolymer E and 25 wt % water was prepared which resulted in a single phase clear solution. Similarly a mixture of 75 wt % of Copolymer F and 25 wt % of methyl ethyl ketone (MEK) was prepared. Then a layer 25 to 30 microns thick of a copolymer A (from Example 1 herein) and the above formulations of copolymers E and F were each applied onto copper boards, and placed in a convection oven set at 80° C. The time to achieve a completely tack-free coating after solvent evaporation was determined by applying pressure with a finger. A fingerprint on the coating indicated a tacky surface. Thickness of the dried coating was approximately 10-15 microns.

The dried coatings were exposed to 1% Na₂CO₃ for 60 seconds to check for solubility of the copolymers in alkaline solution. Insolubility was indicated by almost 100% coating still remaining on the copper board after 60 seconds. Complete solubility was indicated by 100% of coating dissolving after 50 seconds.

| | Time to tack free at | Solubility in 1% Na₂CO₃, |
|---|---|---|
| Copolymer | 80° C. | 60 seconds, |
| A | 5 minutes | Insoluble |
| E in 25% water | 3 minutes | Complete solubility |
| F in 25% MEK | 1 minutes | Partially soluble |

It can been seen that formulations of Copolymers E and F from Examples 7 and 8 respectively are particularly advantageous embodiments of the present invention.

1. A radiation curable composition that is developable in aqueous alkaline solution and which comprises:
(a) a copolymer which is a partial esterification product of a styrene maleic anhydride copolymer with at least two hydroxy containing compounds of Formula I, 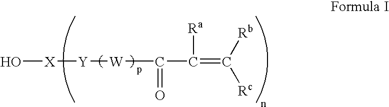
where
p is 0 or 1 (i.e. when p is 0 then Y is directly attached to the carbonyl group);
n is an integer from 1 to 7;
R^{a}, R^{b} and R^{c} are independently H or methyl, preferably R^{a} is methyl or H and R^{b} and R^{c} are H;
X and W independently represent a divalent optionally substituted organo linking moiety optionally selected from a group consisting of one or more optionally substituted hydrocarbo, hydrocarbo ether; poly(hydrocarbo ether); hydrocarbo ester, poly(hydrocarbo ester) and poly(hydrocarbo ether hydrocarbo ester); more optionally selected from the group consisting of: alkylene, alkylene ether, polyether, polyester, alkylene ester and polyether polyester;
Y is oxo (—O—), imino (—NH—) or hydrocarbo substituted imino (—NR₁—, where R₁ is hydrocarbo, optionally alkyl);
(b) optionally a partial esterification product of a styrene maleic anhydride copolymer with one or more hydroxyl containing compounds of the following formulae: 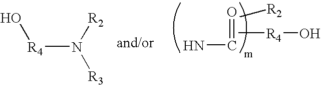
such that
R₂ and R₃ independently represent H or optionally substituted hydrocarbo, preferably optionally substituted alkyl, aryl, cycloalkyl, or arylalkyl
R₄ independently in each case represents a direct bond (i.e. where the OH is attached to the nitrogen or carbonyl) or a divalent optionally substituted organo linking moiety, optionally an optionally substituted hydrocarbo; more optionally an optionally substituted alkylene, arylene, cycloalkylene, or arylalkylene; and
m is 1 or greater; and
(c) optionally an amide containing (meth)acrylate.

2. A radiation curable composition which comprises:
(a) a blend of copolymers which are a partial esterification product of a styrene maleic anhydride copolymer with compounds of Formula II; 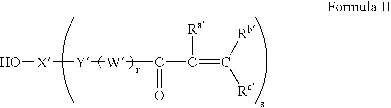
where
r is 0 or 1 (i.e. when r is 0 then Y′ is directly attached to the carbonyl group);
s is an integer from 1 to 7;
R^{a′}, R^{b′} and R^{c′} are independently H or methyl, preferably R^{a′} is methyl or H and R^{b′} and R^{c′} are H;
X′ and W′ independently represent a divalent optionally substituted organo linking moiety optionally selected from a group consisting of one or more optionally substituted hydrocarbo, hydrocarbo ether; poly(hydrocarbo ether); hydrocarbo ester, poly(hydrocarbo ester) and poly(hydrocarbo ether hydrocarbo ester); more optionally selected from the group consisting of: alkylene, alkylene ether, polyether, polyester, alkylene ester and polyether polyester;
Y′ is oxo (—O—), imino (—NH—) or hydrocarbo substituted imino (—NR′₁—, where R′₁ is hydrocarbo, optionally alkyl);
(b) optionally a partial esterification product of a styrene maleic anhydride copolymer with one or more hydroxyl containing compounds of the following formulae: 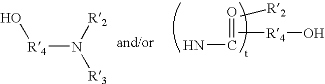
such that
R′₂ and R′₃ independently represent H or optionally substituted hydrocarbo, preferably optionally substituted alkyl, aryl, cycloalkyl, or arylalkyl
R ₄ independently in each case represents a direct bond (i.e. where the OH is attached to the nitrogen or carbonyl) or a divalent optionally substituted organo linking moiety, optionally an optionally substituted hydrocarbo; more optionally an optionally substituted alkylene, arylene, cycloalkylene, or arylalkylene; and
t is 1 or greater; and
(c) an amide containing (meth)acrylate.

3. A radiation curable composition according to either preceding claim, wherein at least 50 mole % of the free anhydride groups in the styrene maleic anhydride copolymer are esterified with hydroxy alkyl (meth)acrylate.

4. A radiation curable composition according to claim 3, wherein less than 50 mole 5 of the free anhydride groups are reacted with hydroxy (meth)acrylates containing ester or ester linkages between the hydroxyl group and the carboxyl group of the (meth)acrylate.

5. A radiation curable composition according to any preceding claim, wherein substantially all of the anhydride groups are esterified.

6. A radiation curable composition according to any preceding claim, wherein the hydroxy (meth)acrylate is selected from the groups consisting of polyethyleneglycol monoacrylate, polyethyleneglycol monomethacrylate, polypropyleneglycol monoacrylate, polypropyleneglycol monomethacrylate, and mixtures of ethylene and propylene glycol such as polyalkyleneglycol monomethacrylate.

7. A radiation curable composition according to claim 1, which includes an amide containing (meth)acrylate.

8. A radiation curable composition according to any of claims 2 to 7, wherein the am ido(meth)acrylate is those prepared from reaction of gamma-butyrolactone and alkylamine, alkanolamine or alkyl diamine to produce amido alcohols, and the amido alcohols are further reacted with methyl (meth)acrylate by transesterification to produce amido (meth)acrylates with the byproduct of mono alcohol which is distilled under vacuum.

9. A radiation curable composition according to any preceding claim, wherein the amido (meth) acrylates are selected from the group consisting of 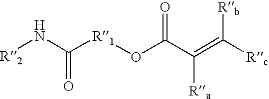
where:
R″₂ is alkyl, aryl, arylalkyl or cycloalkyl;
R″₂ is divalent alkylene, arylene, arylalkylene or cycloalkylene; and
R″ₐ, R″_{b} and R″_{c} are independently H or methyl; preferably R″ₐ is H or methyl and R″_{b} and R″_{c} are both H; 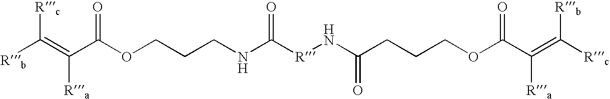
where R′″ₐ, R′″_{b} and R′″_{c} are independently H or methyl; preferably R′″ₐ is H or methyl and R′″_{b} and R′″_{c} are both H; and
R′″ is divalent alkylene, or 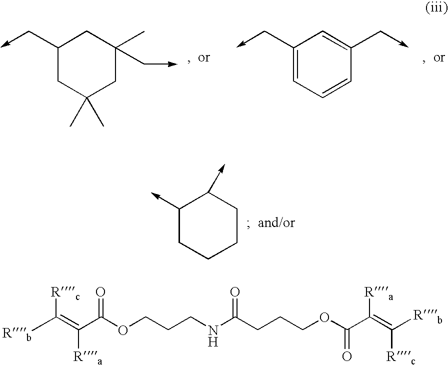
where R″″ₐ, R″″_{b} and R″″_{c} are independently H or methyl; preferably R″″ₐ is H or methyl and R″″_{b} and R″″_{c} are both H.

10. A radiation curable composition according to any one of claims 2 to 9, wherein the weight ratio of amido meth(acrylate) to SMA copolymer is in the respective range from about (1 to 2) to about (1 to 10).

11. A radiation curable composition according to claim 10, wherein the weight ratio of amido meth(acrylate) to SMA copolymer is in the respective range from about (1 to 3) to about (1 to 6).

12. A photo-resist composition comprising a copolymer as defined in any preceding claim, wherein the weight percentage of the ingredients in the composition comprises:
(a) the copolymer in an amount from about 60% to about 80%;
(b) optionally filler(s) in an amount up to about 10%;
(c) multifunctional (meth)acrylate monomer(s) in an amount from about 5% to about 10%;
(d) pigment(s) in an amount from about 1% to about 2%;
(e) optionally wax(es) in an amount from about 1% to about 2%;
(f) rheology additive(s) in an amount from about 1% to about 2%; and/or
(g) photo-initiator(s) in an amount from about 5% to about 7%.

13. A process for making and/or coating an article comprising the steps of:
(a) applying to an article a radiation curable composition as claimed in any preceding claim;
(b) irradiating the article to selectively cure the composition in a pattern thereon;
(c) washing the article in an aqueous alkali solution to remove uncured composition,
(d) etching the article to remove material from the article where the article is uncoated with the cured composition.

14. A process according to claim 13, in which the article is a printed circuit board or printing plate.

15. An article obtained and/or obtainable by a process according to either claim 13 or 14.
